(19) United States
(12) Patent Application Publication
(10) Pub. No.: US 2025/0163690 A1
(43) Pub. Date: May 22, 2025

(54) Dual Shower Head Apparatus

(71) Applicant: Danna Wu, Shantou (CN)

(72) Inventor: Danna Wu, Shantou (CN)

(21) Appl. No.: 19/034,484

(22) Filed: Jan. 22, 2025

(30) Foreign Application Priority Data
Jan. 17, 2025 (CN) 2025201213780

(51) Int. Cl. E03C 1/04; B05B 15/656

(52) U.S. Cl. CPC E03C 1/0408; B05B 15/656

(57) ABSTRACT

A dual shower head apparatus, includes an adjustment rod and a shower head assembly. The adjustment rod includes a supporting rod and adjustment components. At least one end of the supporting rod threadedly matched with the adjusting assembly is provided with the adjustment component. The adjusting assembly is capable of axially moving relative to the supporting rod to adjust the length of the adjustment rod; and the supporting rod is configured as a hollow structure. The shower head assembly includes a first shower head, a second shower head, a first connection pipe, a second connection pipe and a control valve. The control valve is provided with three connection ends that respectively connect to the first shower head, the first connection pipe and an external water source. The first connection pipe and the second connection pipe are connected through the hollow structure of the supporting rod.

### CROSS-REFERENCE TO RELATED APPLICATIONS

The present invention claims the benefit of Chinese Patent Application No. 2025201213780 filed on Jan. 17, 2025, the contents of which are hereby incorporated by reference

### TECHNICAL FIELD

The invention belongs to the technical field of bathroom products, and particularly relates to a dual shower head apparatus.

### TECHNICAL BACKGROUND

Common shower apparatus on the market are mainly installed between two opposite walls. A spring telescopic structure is set at one end of the shower apparatus so that the shower apparatus has a length-adjustable function and can be installed in bathrooms of different widths.

However, the service life of the spring is limited. The spring will age and gradually lose its original elasticity after long-term use, and cannot maintain its original shape and function. As a result, the entire shower apparatus can no longer be firmly supported on the wall and falls. As the shower apparatus is usually arranged above users, if it falls during showering, it will cause serious damage to the user's head.

### INVENTION CONTENT

In order to overcome the defects of the existing technology, the present invention provides a dual shower head apparatus. Threaded adjustment components are arranged at two ends of the supporting rod to make the size of the dual shower head apparatus adjustable, while ensuring the stability of the the connection to ensure the safety of users during showering.

The technical scheme adopted by the present invention for solving the technical problems is as follows:

A dual shower head apparatus includes an adjustment rod and a shower head assembly. The adjustment rod includes a supporting rod and adjustment components. At least one end of the supporting rod is provided with the adjustment component which is capable of axially moving relative to the supporting rod to adjust the length of the adjustment rod, and the supporting rod is threadedly matched with the adjustment component. The supporting rod is configured as a hollow structure. The shower head assembly includes a first shower head, a second shower head, a first connection pipe, a second connection pipe and a control valve. The control valve is provided with three connection ends that respectively connect to the first shower head, the first connection pipe and an external water source. The first connection pipe and the second connection pipe are connected via the hollow structure of the supporting rod.

Further, installment zones are arranged on two ends of the supporting rod. A partition is arranged between the installment zone and the adjustment component. The two installment zones are connected via the supporting rod.

Further, the installment zones includes a first installment zone and a second installment zone. The first installment zone is provided with a first pipe connector connected to the first connection pipe; the second installment zone is provided with a second pipe connector connected to a second connection pipe.

Further, the first pipe connector and the second pipe connector are threadedly connected to the supporting rod.

Further, the adjustment component includes a fixing tube and an adjustment tube. The fixing tube is threadedly connected to an end of the supporting rod, and the adjustment tube is threadedly connected to the fixing tube.

Further, a screw extending axially is arranged inside the fixing tube, and a screw thread hole matched with the screw is arranged on the adjustment tube.

Further, a connection part is arranged on one end of the adjustment tube away from the supporting rod, and the size of the connection part is larger than that of the adjustment tube.

Further, the inner diameter of the fixing tube is matched with the outer diameter of the adjustment tube.

Further, the first connection pipe is a flexible connection pipe.

Further, the control valve is used to control water to flow out of the first shower head and/or the second shower head.

The beneficial effects of the present invention:

The present invention provides a dual shower head apparatus, which is provided with built-in screws at two ends of a supporting rod, and cooperates with an adjustment tube with a screw thread hole. Therefore, its length can be adjusted by utilizing the screw threads, and the stability of the connection can be ensured because of the hardness of the screws to ensure the safety of users during showering, and there is no aging problem of the dual shower head apparatus.

### DESCRIPTION OF FIGURES

FIG. 1 is an overall schematic view of a dual shower head apparatus of the present invention;

FIG. 2 is an exploded view of the dual shower head apparatus of the present invention;

FIG. 3 is a schematic view of an adjustment component of the dual shower head apparatus of the present invention;

FIG. 4 is an exploded view of the adjustment component of the dual shower head apparatus of the present invention;

FIG. 5 is an exploded view of the adjustment component of the dual shower head apparatus of the present invention from another angle;

FIG. 6 is a cross-sectional view of a supporting rod of the dual shower head apparatus of the present invention;

FIG. 7 is a schematic view of a control valve of the dual shower head apparatus of the present invention;

### DESCRIPTION OF MARKS IN FIGURES

1—supporting rod; 11—first installment zone; 12—first pipe connector; 112—first connection hole; 113—second connection hole; 12—second installment zone; 121—second pipe connector; 122—third connection hole; 123—fourth connection hole; 13—first screw thread; 14—partition;

2—adjustment component; 21—fixing tube; 211—screw; 212—fourth screw thread; 22—adjustment tube; 221—screw thread hole; 222—connection part; 23—connection tube; 231—second screw thread; 232—third screw thread;

3—first shower head; 31—first connection pipe; 32—control valve; 4—second shower head; 41—second connection pipe.

### DETAILED DESCRIPTION OF THE EMBODIMENTS

Below is a further detailed description of the present invention based on the figures.

The present embodiment only shows an explanation of the present invention and it is not a limitation to the present invention. The skilled in the art can make modifications to this embodiment as needed without making any creative contributions after reading this specification, which are always protected by the patent law as long as they are within the scope of the claims of the present invention.

It should be noted that when an element is called as being “fixed to” or “arranged on” another element, it can be directly on the other element or indirectly on the other element. When an element is called as being “connected to” another element, it can be directly connected to the other element or indirectly connected to the other element.

It should be noticed that the terms “length”, “width”, “above”, “below”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present invention and simplifying the description, rather than indicating or implying that the device or component must have a specific orientation, construct and operate in a specific orientation, therefore, it understood as a limitation of the present invention.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present invention, “a plurality of” means two or more, unless otherwise specifically defined.

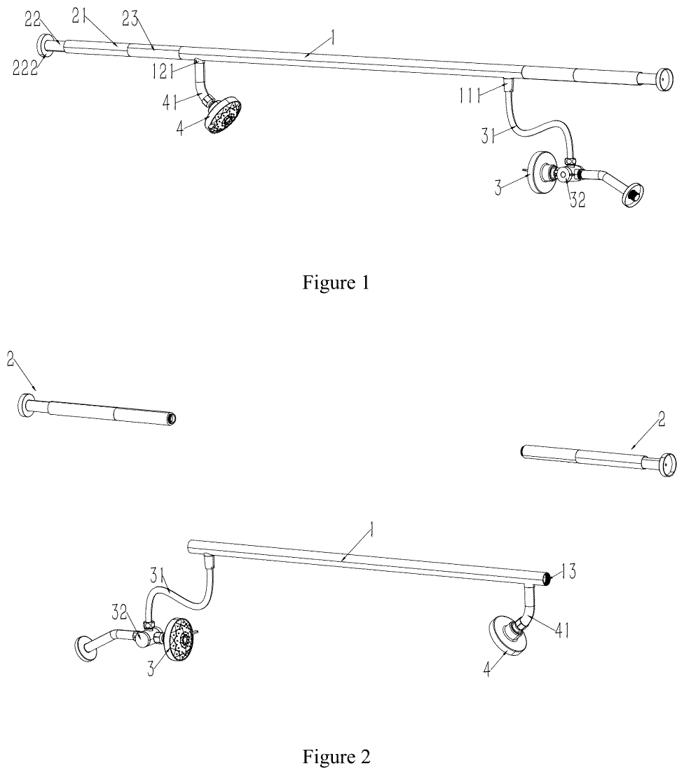

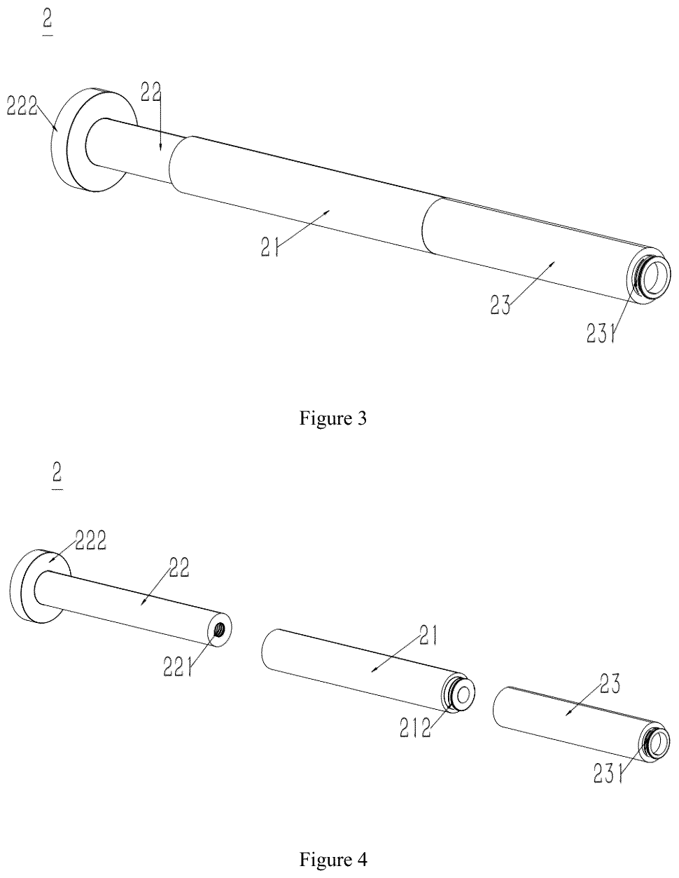

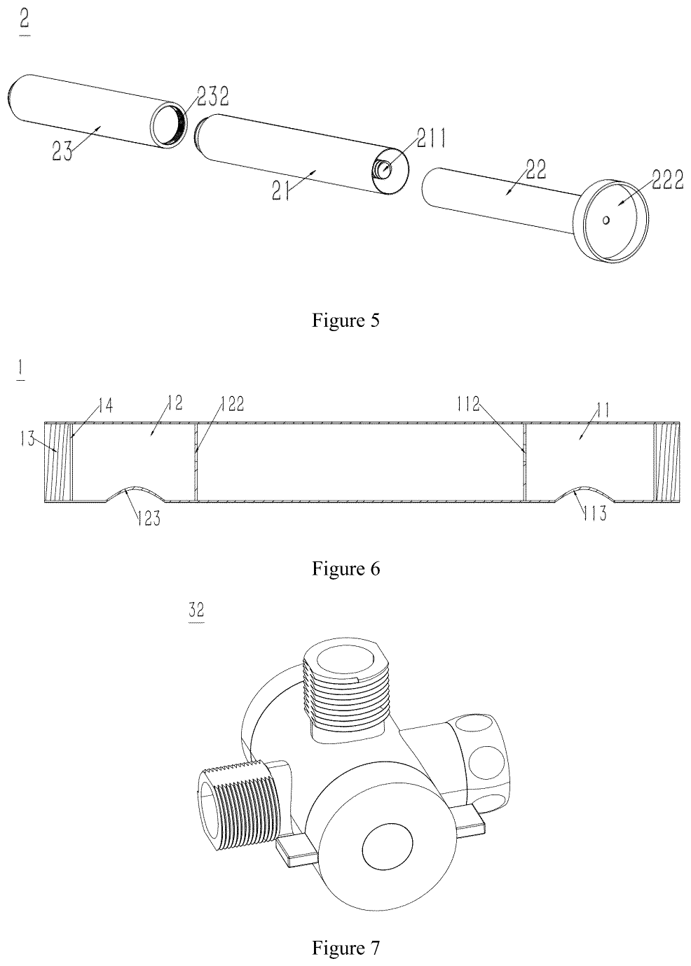

Referring to FIGS. 1 to 7, the present embodiment provides a dual shower head apparatus, including an adjustment rod and a shower head assembly. The adjustment rod includes a supporting rod 1 and adjustment components 2. At least one end of the supporting rod 1 is provided with the adjustment component 2 which is capable of moving axially relative to the supporting rod 1 to adjust the length of the adjustment rod, and the supporting rod 1 is threadedly matched with the adjustment component 2; the supporting rod 1 is configured as a hollow structure. The shower head assembly includes a first shower head 3, a second shower head 4, a first connection pipe 31, a second connection pipe 41 and a control valve 32. The control valve 32 is provided with three connection ends that respectively connect to the first shower head 3, the first connection pipe 31 and an external water source. The first connection pipe 31 is connected to the second connection pipe 41 through the hollow structure of the supporting rod 1.

The adjustment components 2 are threadedly connected to the supporting rod 1, which can ensure that the adjustment rod is firmly fixed in the bathroom and will not fall, so as to ensure the personal safety of users.

In this embodiment, the hollow structure of supporting rod 1 serves as a water channel for connecting the first connection pipe 31 and the second connection pipe 41, and then connecting the first shower head 3 and the second shower head 4, so that the water flow can be smoothly transmitted from the external water source to each shower head to provide users with shower water.

In another embodiment, users can connect the first connection pipe 31 and the second connection pipe 41 with the the supporting rod 1 directly by inserting the first connection pipe 31 and the second connection pipe 41 into the interior of the supporting rod 1. A water flow channel also can be formed in this way to transmit the water flow to each shower head.

Preferably, the control valve 32 is used to control water to flow out from the first shower head 3 and/or the second shower head 4, so as to meet various showering needs of a family.

The control valve 32 in this embodiment is a common three-way control valve 32 on the market, its working principle is based on the flow diversion principle in fluid mechanics. By rotating or moving the valve core inside the control valve 32, users can change the cross-sectional area of the water flow channel to control the water flow direction and flow rate. Those skilled in the art should be familiar with its principles and be able to directly apply them, so no excessive elaboration is given here.

In this embodiment, the first shower head 3 and the second shower head 4 are both silicone shower heads with good flexibility and self-cleaning function, which are not easy to be blocked and can ensure that the water flow is sprayed evenly to provide users with a comfortable shower experience. At the same time, the spraying mode of the first shower head 3 and the second shower head 4 can be adjusted according to users' needs, such as mist spraying, columnar spraying, etc., to meet the preferences of different users for shower water flow.

When in use, the adjustment rod needs to be fixed in the middle part of the opposite wall. By adjusting the relative positions of the adjustment components 2 and the supporting rod 1, the adjustment components 2 at the end of the adjustment rod are abutted against the wall to achieve a supporting effect, which is suitable for bathrooms with smaller widths.

In another embodiment, two ends of the supporting rod 1 of this embodiment are threadedly connected with adjustment components 2, so it is suitable for bathrooms with wider widths. Users can flexibly adjust the position of the shower head assembly in the bathroom to adjust the shower space, providing users with a better shower experience for two people.

Preferably, installment zones are arranged on the two ends of the supporting rod 1. A partition 14 is arranged between the installment zone and the adjustment component 2. The two installment zones are connected via the supporting rod 1.

The installment zones includes a first installment zone 11 and a second installment zone 12. The first installment zone 11 is connected to the interior of the supporting rod 1 through a first connection hole 112, and the second installment zone 12 is connected to the interior of the supporting rod 1 through a third connection hole 122.

Further, the first installment zone 11 is provided with a second connection hole 113 connected to the first pipe connector 111, and the first pipe connector 111 is connected to the first connection pipe 31; the second installment zone 12 is provided with a fourth connection hole 123 connected to the second pipe connector 121, and the second pipe connector 121 is connected to the second connection pipe 41.

Specifically, the first pipe connector 111 and the second pipe connector 121 are threadedly connected to the supporting rod 1. The threaded connection is a type of detachable connection. If there is a leak or other unfavorable condition at the connection, it is convenient for users to repair and replace the parts. In addition, the detachable connection design can also reduce the space required for the product to facilitate express packaging and transportation. And users can assemble and connect the product after it is transported to the destination. Similarly, if the first connection pipe 31 and the second connection pipe 41 are damaged or leaking, users can also repair and replace them easily.

During the actual installment process, a proper amount of sealant needs to be applied to the threaded connection parts of the first pipe connector 111 and the supporting rod 1 and the second pipe connector 121 and the supporting rod 1 respectively, to ensure the sealing of the connection parts and prevent water leakage. At the same time, when tightening the pipe connector, it is necessary to use appropriate tools and operate according to the specified torque to avoid loose connection or damage to the screw thread due to over-tightening or over-loosening.

Preferably, the adjustment component 2 includes a fixing tube 21 and an adjustment tube 22. The fixing tube 21 is connected to the supporting rod 1, and the adjustment tube 22 is threadedly connected to the fixing tube 21.

Specifically, a screw 211 extending axially is arranged inside the fixing tube 21, and a screw thread hole 221 adapted to the screw 211 is arranged on the adjustment tube 22.

Understandably, one end of the adjustment tube 22 is threadedly connected to the screw 211, and other end of the adjustment tube 22 is used to abut against the wall. The relative position of the adjustment tube 22 and the fixing tube 21 can be adjusted by simply rotating the adjustment tube 22 clockwise or counterclockwise, and the length of the adjustment rod can be further adjusted. The simple adjustment and the tight connection improves the users' experience.

Further, a connection part 222 is arranged on one end of the adjustment tube 22 away from the supporting rod 1, and the size of the connection part 222 is larger than or equal to that of the adjustment tube 22.

In actual production use, the size of the connection part 222 is generally larger than that of the adjustment tube 22. Compared with the end of the adjustment tube 22 directly abutting against the wall, the additionally arranged connection part 222 has a larger abutment area against the wall, which can generate greater friction with the wall and make the supporting effect better.

Further, the inner diameter of the fixing tube 21 is adapted to the outer diameter of the adjustment tube 22, so that the adjustment tube 22 and the fixing tube 21 can fit tightly together to prevent loosening and slipping during use, which can ensure users' shower safety.

Preferably, the fixing tube 21 is connected to the supporting rod 1 via a connection tube 23. A first screw thread 13 is arranged at one end of the supporting rod 1, and a second thread 231 is arranged at one end of the connection tube 23. The first screw thread 13 is adapted to the second screw thread 231.

Further, a third screw thread 232 is arranged at one end of the connection tube 23 away from the supporting rod 1, and a fourth screw thread 212 is arranged at the fixing tube 21. The third screw thread 232 is adapted to the fourth screw thread 212.

Preferably, the first connection pipe 31 is a flexible connection pipe.

By arranging a flexible first connection pipe 31, utilizing its stretchable and bendable characteristics, and in combination with adjustment components 2 arranged at the end of the supporting rod 1, the relative position of the first shower head 3 and the second shower head 4 can be adjusted, which provides better flexibility and can meet the shower needs of users of different body shapes.

The method for using the dual shower head shower apparatus provided in this embodiment is as follows:

Users needs to fix the adjustment rod in the middle position of the opposite wall. First, adjust the relative positions of the adjustment components 2 and the supporting rod 1 according to the actual width of the bathroom, to make the adjustment components 2 at two ends of the adjustment rod contact with the wall, so as to achieve a supporting effect. During the specific operation, users can easily adjust the length of the adjustment rod to adapt to bathrooms of different widths by only rotating the adjustment tube 22. After adjusting the position of the adjustment rod, connect the control valve 32 to the external water source and ensure that the connection is firm. Then, users can control the water to flow out from the first shower head 3, the second shower head 4, or from both shower heads at the same time through the control valve 32 according to their needs. If the relative position of the first shower head 3 and the second shower head 4 needs to be adjusted, it can be achieved by stretching and bending the first connection pipe 31.

The dual shower head apparatus provided in this embodiment is suitable for bathrooms of various sizes. Whether it is a compact bathroom in a small apartment or a spacious bathroom in a large apartment, the apparatus can be firmly installed in a suitable position by adjusting the length of the adjustment rod. For some irregularly shaped bathrooms, the positions of the adjustment component 2 and the shower head assembly can also be flexibly adjusted to meet the shower users' needs.

It could be understood that under the guidance of the above embodiments, those skilled in the filed can combine various implementation methods in the above embodiments to obtain technical solutions of multiple implementation methods.

The above description is only a preferred embodiment of the present invention and is not to limit the present invention. Any modifications, equivalent substitutions and improvements made within the spirit and principles of the present invention should be included in the protection scope of the present invention.

1. A dual shower head apparatus comprises an adjustment rod and a shower head assembly, wherein the adjustment rod comprises a supporting rod and adjustment components; at least one end of the supporting rod is provided with the adjustment component which is capable of axially moving relative to the supporting rod to adjust the length of the adjustment rod, and the supporting rod is threadedly matched with the adjustment component; the supporting rod is configured as a hollow structure; the shower head assembly comprises a first shower head, a second shower head, a first connection pipe, a second connection pipe and a control valve; the control valve is provided with three connection ends that respectively connect to the first shower head, the first connection pipe and an external water source; the first connection pipe and the second connection pipe are connected through the hollow structure of the supporting rod.

2. The dual shower head apparatus according to claim 1, wherein installment zones are arranged on two ends of the supporting rod, and a partition is respectively arranged between the installment zone and the adjustment component; and the two installment zones are connected via the supporting rod.

3. The dual shower head apparatus according to claim 2, wherein the installment zones include a first installment zone and a second installment zone; the first installment zone is provided with a first pipe connector connected to the first connection pipe; the second installment zone is provided with a second pipe connector connected to the second connection pipe.

4. The dual shower head apparatus according to claim 3, wherein the first pipe connector and the second pipe connector are threadedly connected to the supporting rod.

5. The dual shower head apparatus according to claim 1, wherein the adjustment component comprises a fixing tube and an adjustment tube; the fixing tube is threadedly connected to an end of the supporting rod, and the adjustment tube is threadedly connected to the fixing tube.

6. The dual shower head apparatus according to claim 5, wherein a screw extending axially is arranged inside the fixing tube, and a screw thread hole adapted to the screw is arranged on the adjustment tube.

7. The dual shower head apparatus according to claim 5, wherein a connection part is arranged on one end of the adjustment tube away from the supporting rod, and a size of the connection part is larger than that of the adjustment tube.

8. The dual shower head apparatus according to claim 5, wherein an inner diameter of the fixing tube is matched with an outer diameter of the adjustment tube.

9. The dual shower head apparatus according to claim 1, wherein the first connection pipe is a flexible connection pipe.

10. The dual shower head apparatus according to claim 1, wherein the control valve is used to control water to flow out of the first shower head and/or the second shower head.
